(19) United States
(12) Patent Application Publication
(10) Pub. No.: US 2025/0004193 A1
(43) Pub. Date: Jan. 2, 2025

(54) BENDABLE, MODAL-CONDITIONING, SINGLE-MODE OPTICAL FIBERS AND OPTICAL TRANSCEIVERS COMPRISING THE SAME

(71) Applicant: CORNING INCORPORATED, CORNING, NY (US)

(72) Inventors: Hao Chen, Pudong (CN); Xin Chen, Painted Post, NY (US); Ming-Jun Li, Horseheads, NY (US); Qi Wu, Painted Post, NY (US)

(21) Appl. No.: 18/738,204

(22) Filed: Jun. 10, 2024

Related U.S. Application Data
(60) Provisional application No. 63/523,975, filed on Jun. 29, 2023.

(51) Int. Cl. G02B 6/028

(52) U.S. Cl. CPC G02B 6/0281

(57) ABSTRACT

A modal-conditioning, single-mode fiber generally includes a core portion and a cladding portion. The core portion includes a core and an inner cladding. The core comprises an outer radius r₁ and a maximum relative refractive index Δ₁ₘₐₓ. The inner cladding comprises an outer radius r₂ and a relative refractive index Δ₂. The cladding portion surrounds the core portion and includes a low-index trench surrounding the inner cladding. The low-index trench includes an outer radius r₃ and a minimum relative refractive index Δ₃ₘᵢₙ. The radius r₂ of the inner cladding may be greater than 12 μm and Δ₁ₘₐₓ>Δ₂>Δ₃ₘᵢₙ. The fiber comprises a mode field diameter MFD greater than or equal to 12 μm and less than or equal to 16 μm at a wavelength of 1310 nm and a 30 mm diameter bend loss of less than or equal to 0.5 dB/turn at 1310 nm.

This application claims the benefit of priority under 35 U.S.C § 120 of U.S. Provisional Application Ser. No. 63/523,975 filed on Jun. 29, 2023, the content of which is relied upon and incorporated herein by reference in its entirety.

### BACKGROUND

### Field

The present specification generally relates to optical fibers and, more specifically, to bendable, modal-conditioning, single-mode optical fibers and optical fiber transmission systems comprising the same.

### Technical Background

Multimode fibers (MMF) have been widely deployed in local area networks such as campuses, hotels, office buildings, and data centers for more than two decades. Previously, local area network installations only needed to support transceiver speeds of 1 gigabytes per second (Gbps) using OM1 MMF, which has a core diameter of 62.5 microns. Relatively recent installations may use 50 micron core diameter OM2, OM3, or OM4 optical fibers that offer higher modal bandwidth with optimized index profiles.

The modal bandwidth limitations of the installed multimode fibers create an impediment to upgrading the local area networks to higher speeds. Replacing the MMF with single mode fibers is one option. However, it is extremely difficult and expensive, in some cases, to remove the older MMF from the existing physical infrastructure and replace the MMF with new fibers compatible with the higher transceiver speeds of modern optical fiber networks.

A lower cost solution to facilitate compatibility of installed multimode fibers with higher transceiver speeds may be realized with single mode transmission in existing, legacy networks using the fundamental mode (i.e., the LP01 mode) where modal dispersion is eliminated.

Accordingly, a need exists for alternative optical fibers to facilitate single mode transmission in existing networks comprising MMF using the fundamental mode and optical fiber transmission systems, such as optical transceivers, comprising the same.

### SUMMARY

According to a first aspect A1, a modal-conditioning, single-mode fiber (MC-SMF) comprising: a core portion comprising a core and an inner cladding surrounding and directly contacting the core, wherein: the core comprises an outer radius r₁ and a maximum relative refractive index Δ₁ₘₐₓ relative to undoped silica glass; and the inner cladding comprises an outer radius r₂ and a relative refractive index Δ₂ relative to undoped silica glass; and a cladding portion surrounding the core portion, the cladding portion comprising a low-index trench surrounding and directly contacting the inner cladding, the low-index trench comprising an outer radius r₃ and a minimum relative refractive index Δ₃ₘᵢₙ relative to undoped silica glass, wherein: r₂ is greater than 12.0 μm; Δ₁ₘₐₓ>Δ₂>Δ₃ₘᵢₙ; the MC-SMF comprises a mode field diameter MFD greater than or equal to 12.0 μm and less than or equal to 16.0 μm at a wavelength of 1310 nm; and the MC-SMF comprises a 30 mm diameter bend loss of less than or equal to 0.50 dB/turn at 1310 nm.

A second aspect A2 includes the MC-SMF of Aspect A1, wherein Δ₁ₘₐₓ is greater than or equal to 0.10% and less than or equal to 0.15%.

A third aspect A3 includes the MC-SMF of any preceding aspect, wherein r₁ is greater than or equal to 5.5 μm and less than or equal to 7.5 μm.

A fourth aspect A4 includes the MC-SMF of any preceding aspect, wherein the core has a relative refractive index profile with an alpha value greater than or equal to 5.

A fifth aspect A5 includes the MC-SMF of any preceding aspect, wherein Δ₂ is greater than or equal to −0.10% and less than or equal to 0.10%.

A sixth aspect A6 includes the MC-SMF of any preceding aspect, wherein r₂ is greater than 15.0 μm and less than or equal to 30.0 μm.

A seventh aspect A7 includes the MC-SMF of any preceding aspect, wherein Δ₁ₘₐₓ−Δ₂ is greater than or equal to 0.10% and less than or equal to 0.15%.

An eighth aspect A8 includes the MC-SMF of any preceding aspect, wherein Δ₃ₘᵢₙ is greater than or equal to −0.70% and less than or equal to −0.10%.

A ninth aspect A9 includes the MC-SMF of any preceding aspect, wherein the low-index trench has a radial width equal to r₃−r₂ and r₃−r₂ is greater than or equal to 32.5 μm and less than or equal to 50.5 μm.

A tenth aspect A10 includes the MC-SMF of any preceding aspect, wherein the low-index trench has a volume profile V_{T} and |V_{T}| is greater than or equal to 50% Δμm² and less than or equal to 900% Δμm².

An eleventh aspect A11 includes the MC-SMF of any preceding aspect, wherein the cladding portion further comprises an outer cladding surrounding and directly contacting the low-index trench, the outer cladding comprising an outer radius r₄ and a relative refractive index Δ₄ relative to undoped silica glass.

A twelfth aspect A12 includes the MC-SMF of aspect A11, wherein the low-index trench has a radial width equal to r₃−r₂ and r₃−r₂ is greater than or equal to 2.0 μm and less than or equal to 10.0 μm.

A thirteenth aspect A13 includes the MC-SMF of aspects A11-A12, wherein the low-index trench has a volume profile V_{T} and |V_{T}| is greater than or equal to 50% Δμm² and less than or equal to 150% Δμm².

A fourteenth aspect A14 includes the MC-SMF of aspects A11-A13, wherein 2*r₄ is greater than or equal to 80.0 μm and less than or equal to 125.0 μm.

A fifteenth aspect A15 includes the MC-SMF of aspects A11-A14, wherein Δ₄ is greater than or equal to 0.00% and less than or equal to 0.50%.

A sixteenth aspect A16 includes the MC-SMF of aspects A11-A15, wherein Δ₄≥Δ₂ and Δ₄>Δ₃ₘᵢₙ.

A seventeenth aspect A17 includes the MC-SMF of any preceding aspect, wherein the MC-SMF comprises a fiber core cutoff wavelength of less than or equal to 1300 nm.

An eighteenth aspect A18 includes the MC-SMF of any preceding aspect, wherein the mode field diameter MFD is greater than or equal to 13.0 μm and less than or equal to 15.0 μm at a wavelength of 1310 nm.

A nineteenth aspect A19 includes the MC-SMF of any preceding aspect, wherein the mode field diameter MFD is greater than or equal to 14.0 μm and less than or equal to 18.0 μm at a wavelength of 1550 nm.

A twentieth aspect A20 includes the MC-SMF of any preceding aspect, wherein the MC-SMF comprises a 30 mm diameter bend loss of less than or equal to 0.10 dB/turn at 1310 nm.

A twenty-first aspect A21 includes the MC-SMF of any preceding aspect, wherein the MC-SMF comprises a 30 mm diameter bend loss of less than or equal to 0.80 dB/turn at 1550 nm.

A twenty-second aspect A22 includes the MC-SMF of any preceding aspect, wherein the MC-SMF comprises a length greater than or equal to 1.0 cm and less than or equal to 5.0 cm.

A twenty-third aspect A23 includes a modal-conditioning, single-mode fiber (MC-SMF) comprising: a core portion comprising a core and an inner cladding surrounding and directly contacting the core, wherein: the core comprises an outer radius r₁ and a maximum relative refractive index Δ₁ₘₐₓ relative to undoped silica glass; and the inner cladding comprises an outer radius r₂ and a relative refractive index Δ₂ relative to undoped silica glass; and a cladding portion surrounding the core portion, the cladding portion comprising a low-index trench surrounding and directly contacting the inner cladding, the low-index trench comprising an outer radius r₃ and a minimum relative refractive index Δ₃ₘᵢₙ relative to undoped silica glass, wherein: Δ₁ₘₐₓ>Δ₂>Δ₃ₘᵢₙ; Δ₂ is greater than or equal to −0.10% and less than 0.10%; the MC-SMF comprises a mode field diameter MFD greater than or equal to 12.0 μm and less than or equal to 16.0 μm at a wavelength of 1310 nm; and the MC-SMF comprises a 20 mm diameter bend loss of less than or equal to 0.50 dB/turn at 1310 nm.

A twenty-fourth aspect A24 includes the MC-SMF of aspect A23, wherein Δ₁ₘₐₓ is greater than or equal to 0.10% and less than or equal to 0.15%.

A twenty-fifth aspect A25 includes the MC-SMF of any of aspects A23-A24, wherein r₁ is greater than or equal to 5.5 μm and less than or equal to 7.5 μm.

A twenty-sixth aspect A26 includes the MC-SMF of any of aspects A23-A25, wherein the core has a relative refractive index profile with an alpha value greater than or equal to 5.

A twenty-seventh aspect A27 includes the MC-SMF of any of aspects A23-A26, wherein r₂ is greater than or equal to 12.0 μm and less than or equal to 30.0 μm.

A twenty-eighth aspect A28 includes the MC-SMF of any of aspects A23-A27, wherein Δ₁ₘₐₓ−Δ₂ is greater than or equal to 0.10% and less than or equal to 0.15%.

A twenty-ninth aspect A29 includes the MC-SMF of any of aspects A23-A28, wherein Δ₃ₘᵢₙ is greater than or equal to −0.70% and less than or equal to −0.10%.

A thirtieth aspect A30 includes the MC-SMF of any of aspects A23-A29, wherein the low-index trench has a radial width equal to r₃−r₂ and r₃−r₂ is greater than or equal to 32.5 μm and less than or equal to 50.5 μm.

A thirty-first aspect A31 includes the MC-SMF of any of aspects A23-A30, wherein the low-index trench has a volume profile V_{T} and |V_{T}| is greater than or equal to 50% Δμm² and less than or equal to 900% Δμm².

A thirty-second aspect A32 includes the MC-SMF of any of aspects A23-A31, wherein the cladding portion further comprises an outer cladding surrounding and directly contacting the low-index trench, the outer cladding comprising an outer radius r₄ and a relative refractive index Δ₄ relative to undoped silica glass.

A thirty-third aspect A33 includes the MC-SMF of aspect A32, wherein the low-index trench has a radial width equal to r₃−r₂ and r₃−r₂ is greater than or equal to 2.0 μm and less than or equal to 10.0 μm.

A thirty-fourth aspect A34 includes the MC-SMF of any of aspects A32-A33, wherein the low-index trench has a volume profile V_{T} and |V_{T}| is greater than or equal to 50% Δμm² and less than or equal to 150% Δμm².

A thirty-fifth aspect A35 includes the MC-SMF of any of aspects A32-A34, wherein 2*r₄ is greater than or equal to 80.0 μm and less than or equal to 125.0 μm.

A thirty-sixth aspect A36 includes the MC-SMF of any of aspects A32-A35, wherein Δ₄ is greater than or equal to 0.00% and less than or equal to 0.50%.

A thirty-seventh aspect A37 includes the MC-SMF of any of aspects A32-A36, wherein Δ₄≥Δ₂ and Δ₄>Δ₃ₘᵢₙ.

A thirty-eighth aspect A38 includes the MC-SMF of any of aspects A23-A37, wherein the MC-SMF comprises a fiber core cutoff wavelength of less than or equal to 1300 nm.

A thirty-ninth aspect A39 includes the MC-SMF of any of aspects A23-A38, wherein the mode field diameter MFD is greater than or equal to 13.0 μm and less than or equal to 15.0 μm at a wavelength of 1310 nm.

A fortieth aspect A40 includes the MC-SMF of any of aspects A23-A39, wherein the mode field diameter MFD is greater than or equal to 14.0 μm and less than or equal to 18.0 μm at a wavelength of 1550 nm.

A forty-first aspect A41 includes the MC-SMF of any of aspects A23-A40, wherein the MC-SMF comprises a 30 mm diameter bend loss of less than or equal to 0.10 dB/turn at 1310 nm.

A forty-second aspect A42 includes the MC-SMF of any of aspects A23-A41, wherein the MC-SMF comprises a 30 mm diameter bend loss of less than or equal to 0.80 dB/turn at 1550 nm.

A forty-third aspect A43 includes the MC-SMF of any of aspects A23-A42, wherein the MC-SMF comprises a length greater than or equal to 1.0 cm and less than or equal to 5.0 cm.

A forty-fourth aspect A44 includes an optical transceiver comprising: a housing; at least one receiver positioned in the housing and optically coupled to an input receptacle with an optical fiber; at least one transmitter positioned in the housing and optically coupled to an output receptacle with a modal-conditioning, single-mode fiber, wherein: the MC-SMF comprises a mode field diameter MFD greater than or equal to 12.0 μm and less than or equal to 16.0 μm at a wavelength of 1310 nm; and the MC-SMF comprises a 30 mm diameter bend loss of less than or equal to 0.50 dB/turn at 1310 nm.

A forty-fifth aspect A45 includes the optical transceiver of aspect A44, wherein the MC-SMF comprises: a core portion comprising a core and an inner cladding surrounding and directly contacting the core, wherein: the core comprises an outer radius r₁ and a maximum relative refractive index Δ₁ₘₐₓ relative to undoped silica glass; and the inner cladding comprises an outer radius r₂ and a relative refractive index Δ₂ relative to undoped silica glass; and a cladding portion surrounding the core portion, the cladding portion comprising a low-index trench surrounding and directly contacting the inner cladding, the low-index trench comprising an outer radius r₃ and a minimum relative refractive index Δ3 min relative to undoped silica glass, wherein: r₂ is greater than 12.0 μm; and Δ₁ₘₐₓ>Δ₂>Δ₃ₘᵢₙ.

A forty-sixth aspect A46 includes the optical transceiver of aspect A45, wherein the cladding portion of the MC-SMF further comprises an outer cladding surrounding and directly contacting the low-index trench, the outer cladding comprising an outer radius r₄ and a relative refractive index Δ4 relative to undoped silica glass.

A forty-seventh aspect A47 includes the optical transceiver of aspect A44, wherein the MC-SMF comprises: a core portion comprising a core and an inner cladding surrounding and directly contacting the core, wherein: the core comprises an outer radius r₁ and a maximum relative refractive index Δ₁ₘₐₓ relative to undoped silica glass; and the inner cladding comprises an outer radius r₂ and a relative refractive index Δ₂ relative to undoped silica glass; and a cladding portion surrounding the core portion, the cladding portion comprising a low-index trench surrounding and directly contacting the inner cladding, the low-index trench comprising an outer radius r₃ and a minimum relative refractive index Δ₃ₘᵢₙ relative to undoped silica glass, wherein: Δ₁ₘₐₓ>Δ₂>Δ₃ₘᵢₙ; and Δ₂ is greater than or equal to −0.10% and less than 0.10%.

A forty-eighth aspect A48 includes the optical transceiver of aspect A47, wherein the cladding portion of the MC-SMF further comprises an outer cladding surrounding and directly contacting the low-index trench, the outer cladding comprising an outer radius r₄ and a relative refractive index Δ₄ relative to undoped silica glass.

Additional features and advantages of the optical fibers described herein and transmission systems comprising the same will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a radial cross section of an optical fiber according to one or more embodiments shown and described herein;

FIG. 2 graphically depicts the relative refractive index profile (Δ(%)) of the optical fiber of FIG. 1 as a function of the radius R of the glass portion of the optical fiber where the line Δ₀ indicates Δ %=0, according to one or more embodiments shown and described herein;

FIG. 3 graphically depicts the relative refractive index profile (Δ(%)) as a function of radius of the modeled optical fibers of Examples 4, 8, and 9;

FIG. 4 graphically depicts the relative refractive index profile (Δ(%)) as a function of radius of the optical fibers of Examples 10-13;

FIG. 5 schematically depicts the experimental set-up for testing the performance of the mode-conditioning, single-mode fibers described herein;

FIG. 6 graphically depicts the relative refractive index profile (Δ(%)) as a function of radius of the optical fibers of Examples 14-15;

FIG. 7 graphically depicts the relative refractive index profile (Δ(%)) as a function of radius of the optical fibers of Examples 16-17; and

FIG. 8 schematically depicts an optical transceiver comprising a modal-conditioning, single-single mode fiber according to one or more embodiments described herein.

### DETAILED DESCRIPTION

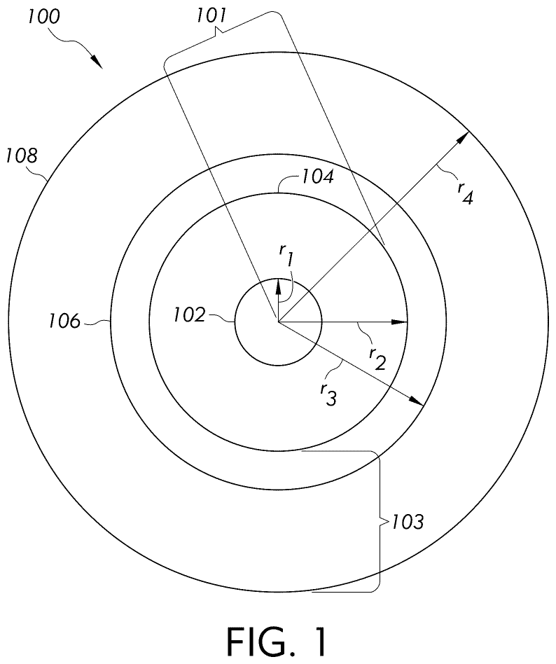

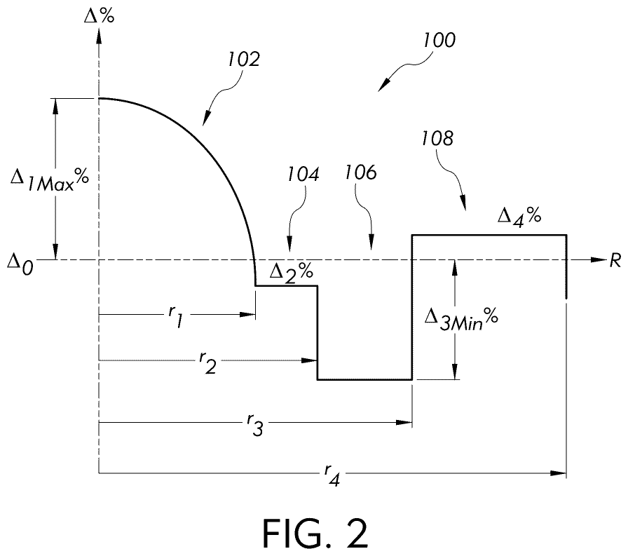

Reference will now be made in detail to embodiments of modal-conditioning, single-mode fibers described herein and optical transceivers comprising the same, examples of which are illustrated in the accompanying drawings. Whenever possible, the same reference numerals will be used throughout the drawings to refer to the same or like parts. One embodiment of a modal-conditioning, single-mode fiber (MC-SMF) is depicted in FIGS. 1 and 2, and is designated generally throughout by the reference numeral 100. In embodiments, the modal-conditioning, single-mode fiber (MC-SMF) generally includes a core portion and a cladding portion. The core portion includes a core and an inner cladding surrounding and directly contacting the core. The core comprises an outer radius r₁ and a maximum relative refractive index Δ₁ₘₐₓ relative to undoped silica glass. The inner cladding comprises an outer radius r₂ and a relative refractive index Δ₂ relative to undoped silica glass. The cladding portion surrounds the core portion and includes a low-index trench surrounding and directly contacting the inner cladding. The low-index trench includes an outer radius r₃ and a minimum relative refractive index Δ₃ₘᵢₙ relative to undoped silica glass. The radius r₂ of the inner cladding may be greater than 12.0 μm and Δ₁ₘₐₓ>Δ₂>Δ₃ₘᵢₙ. The MC-SMF comprises a mode field diameter MFD greater than or equal to 12.0 μm and less than or equal to 16.0 μm at a wavelength of 1310 nm and a 30 mm diameter bend loss of less than or equal to 0.50 dB/turn at 1310 nm. Various embodiments of modal-conditioning, single-mode fibers and optical transceivers comprising the same will be described herein with specific reference to the appended drawings.

The following terminology will be used in conjunction with the optical fibers described herein:

The term “refractive index profile” or “relative refractive index profile,” as used herein, is the relationship between the refractive index or the relative refractive index and the radius R of the fiber.

The term “relative refractive index,” as used herein, is defined as:

$$Δ ( r ) \% = 100 \times \frac{( {n ( r )}^{2} - {n}_{REF}^{2} )}{2 {n ( r )}^{2}} ,$$

where n(r) is the refractive index at radius r of the optical fiber, unless otherwise specified, and r=0 corresponds to the centerline of the fiber. The relative refractive index is defined at 1550 nm unless otherwise specified. In the embodiments described herein, the reference index n_{REF} is the refractive index of pure (i.e., un-doped) silica glass (i.e., n_{REF}=1.444374 at a wavelength of 1550 nm). As used herein, the relative refractive index is represented by A and its values are given in units of “%,” unless otherwise specified. In cases where the refractive index of a region is less than the reference index n_{REF}, the relative refractive index percent is negative and is referred to as having a depressed region or depressed-index, and the minimum relative refractive index is calculated at the point at which the relative index is most negative unless otherwise specified. In cases where the refractive index of a region is greater than the reference index n_{REF}, the relative refractive index percent is positive and the region can be said to be raised or to have a positive index.

The term “up-dopant,” as used herein, refers to a dopant that raises the refractive index of glass relative to pure, un-doped SiO₂. The term “down-dopant,” as used herein, is a dopant that has a propensity to lower the refractive index of glass relative to pure, un-doped SiO₂. An up-dopant may be present in a region of an optical fiber having a negative relative refractive index when accompanied by one or more other dopants that are not up-dopants. Likewise, one or more other dopants that are not up-dopants may be present in a region of an optical fiber having a positive relative refractive index. A down-dopant may be present in a region of an optical fiber having a positive relative refractive index when accompanied by one or more other dopants that are not down-dopants. Likewise, one or more other dopants that are not down-dopants may be present in a region of an optical fiber having a negative relative refractive index.

The term “α-profile” or “alpha profile,” as used herein, refers to a relative refractive index profile, expressed in terms of Δ which is in units of “%,” where r is the radius and which follows the equation,

$$Δ = {Δ}_{1 max} [ 1 - {( \frac{r}{{r}_{1}} )}^{α} ] ,$$

where Δ₁ₘₐₓ is the maximum relative refractive index, r₁ is the radius of the core, r is in the range r₁≤r≤r_{f}, A is as defined above, r₁ is the initial point of the α-profile, r_{f} is the final point of the α-profile, and α is an exponent which is a real number. For a graded index profile, the alpha value is less than 10. The term “parabolic,” as used herein, includes substantially parabolically shaped refractive index profiles which may vary slightly from a core a value of 2.0 at one or more points in the core, as well as profiles with minor variations and/or a centerline dip.

One measure of the bend performance of the optical fibers described herein is macrobend performance. Macrobend performance is determined according to FOTP-62 (JEC-60793-1-47) by wrapping one or more turns of optical fiber around a mandrel with a prescribed diameter, e.g., 20 mm, 30 mm, and/or a 40 mm diameter mandrel and measuring the increase in attenuation due to the bending. The measured bend loss is the difference of the attenuation under the prescribed bend condition to the attenuation without the bend.

Mode field diameter (MFD) is a measure of the spot size or beam width of light propagating in a single mode fiber. Mode field diameter is a function of the source wavelength, fiber core radius and fiber refractive index profile. MFD is measured using the Peterman II method where:

$$M F D = 2 w ,$$

$$and$$

$${w}^{2} = 2 \frac{{\int }_{0}^{∞} {E}^{2} rdr}{{\int }_{0}^{∞} {( dE / dr )}^{2}} rdr$$

where E is the electric field distribution in the fiber and r is the radius of the fiber.

The cutoff wavelength of a mode is the minimum wavelength beyond which a mode ceases to propagate in the optical fiber. The cutoff wavelength of a single mode fiber is the minimum wavelength at which an optical fiber will support only one propagating mode. The cutoff wavelength of a single mode fiber corresponds to the highest cutoff wavelength among the higher order modes. Typically, the highest cutoff wavelength among the higher order modes corresponds to the cutoff wavelength of the LP11 mode. If the operative wavelength is below the cutoff wavelength, multimode operation may take place and the introduction of additional sources of dispersion may limit a fiber's information carrying capacity. A mathematical definition can be found in Single Mode Fiber Optics, Jeunhomme, pp. 39 44, Marcel Dekker, New York, 1990 wherein the theoretical fiber cutoff is described as the wavelength at which the mode propagation constant becomes equal to the plane wave propagation constant in the outer cladding. This theoretical wavelength is appropriate for an infinitely long, perfectly straight fiber that has no diameter variations.

In the present specification, the fiber core cutoff wavelength is reported as the theoretical cutoff wavelength for a fiber based on the core portion of the profile with a uniform cladding by extending the inner cladding to infinity irrespective of the structure of the optical fiber outside the core portion. The fiber core cutoff wavelength ensures the core portion of the fiber is single moded although the cladding portion may guide higher order modes. The fiber core cutoff wavelength can be determined by measuring the refractive index profile of the fiber using, for example, an IFA-100 Interferometric Fiber Analyzer from Interfiber Analysis, LLC, Sharon, MA 02067, USA. The measured core and inner cladding refractive index profile is used to calculate the theoretical cutoff wavelength as described in Single Mode Fiber Optics, Jeunhomme, pp. 39 44, Marcel Dekker, New York, 1990 assuming the inner cladding extends to infinity.

Unless otherwise specified herein, measurements of the properties of the optical fiber are taken at an operating wavelength of at least one of 1310 nm and 1550 nm. Unless otherwise specified herein, optical properties are reported for the LP01 mode.

The terms “microns” and “μm” are used interchangeably herein.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

As noted herein, the modal bandwidth of multimode fibers (MMFs) in legacy local area networks creates an impediment to upgrading the local area networks to higher speeds. A low-cost solution to facilitate compatibility with higher transceiver speeds may be supported by utilizing single mode transmission in existing, legacy networks using the fundamental mode (i.e., the LP01 mode) where modal dispersion is eliminated. To enable fundamental mode transmission in MMF, a mode matching fiber is needed to launch the fundamental mode of light into the MMF network and thereby avoid multipath interference (MPI) issues.

Disclosed herein are optical fibers, specifically modal-conditioning, single-mode fibers (also referred to as mode-matching fibers) that enable LP01 transmission over 50.0 micron core diameter and 62.5 micron core diameter MMF. The optical fibers disclosed herein facilitate launching and propagating the fundamental mode of an optical signal emitted by an optical transceiver into the MMF of a legacy local area network.

The optical fibers disclosed herein have relatively low bending losses for 20 mm and 30 mm bend conditions such that the optical fiber can be used inside optical transceiver equipment with relatively compact packaging form factors. While the optical fibers described herein have the desired bend performance, they also possess other attributes for providing modal conditioning and mode matching (i.e., for facilitating LP01 transmission in a connected MMF). For example, the optical fibers disclosed herein exhibit mode field diameters (MFD) of around 14.0 μm at wavelengths of 1310 nm and fiber core cutoff wavelengths of less than 1300 nm such that the optical fibers are single-moded at very short lengths, such as lengths of optical fibers which can be readily incorporated in optical transceiver equipment with relatively compact packaging form factors. Also disclosed herein are optical transceivers comprising such optical fibers.

FIG. 1 schematically depicts a radial cross section of one embodiment of an optical fiber 100, also referred to herein as a modal-conditioning, single-mode fiber (MC-SMF), or a mode-matching fiber. The optical fibers described herein are single mode optical fibers meaning that the fibers support the propagation of a single mode of electromagnetic radiation in the core above a specified wavelength (i.e., the fiber core cutoff wavelength). The optical fibers 100 described herein generally comprise a core portion 101 and a cladding portion 103. The core portion 101 comprises a core 102 and an inner cladding 104. The cladding portion 103 comprises a low-index trench 106. In embodiments, the cladding portion 103 may optionally comprise an outer cladding 108 (as depicted in FIGS. 1 and 2). However, in other embodiments, the cladding portion 103 does not comprise an outer cladding, such as when the cladding portion 103 only comprises a low-index trench 106 (i.e., as depicted in FIG. 7). The structure and composition of the optical fibers as well as the properties of the optical fibers will be described in more detail herein.

Referring to FIGS. 1 and 2, a radial cross section of one embodiment of an optical fiber 100 (FIG. 1) and the corresponding relative refractive index profile (FIG. 2) of the optical fiber 100 are depicted. The relative refractive index of the optical fiber 100 is plotted as a function of the radius R from the axial centerline of the optical fiber 100. As noted herein, the optical fiber 100 generally comprises a core portion 101 and a cladding portion 103. In the embodiments described herein, the core portion 101 is positioned within the cladding portion 103. The core portion 101 and the cladding portion 103 are concentric such that the cross section of the optical fiber 100 is generally circular symmetric with respect to the center of the core portion 101. The core portion 101 comprises the core 102 and the inner cladding 104. In the embodiments described herein, the core 102 has a maximum relative refractive index Δ₁ₘₐₓ (relative to pure (i.e., un-doped) silica glass). The inner cladding 104 surrounds the core 102 and has a relative refractive index Δ₂ (relative to pure silica glass). In the embodiments described herein, the inner cladding 104 is in direct contact with the core 102.

The cladding portion 103 comprises the low-index trench 106 and, optionally, the outer cladding 108. Accordingly, while FIGS. 1 and 2 depict the optical fiber 100 as comprising an outer cladding 108, it should be understood that the outer cladding 108 is optional and that, in some embodiments, the cladding portion 103 of the optical fiber 100 only comprises the low-index trench 106 (i.e., as depicted in FIG. 7). The low-index trench 106 surrounds the core portion 101 and has a relative refractive index Δ₃ (relative to un-doped silica glass) and a minimum relative refractive index Δ₃ₘᵢₙ (relative to un-doped silica glass).

In embodiments where the cladding portion 103 optionally comprises an outer cladding 108 (as depicted in FIGS. 1 and 2), the outer cladding 108 surrounds the low-index trench 106 and has a relative refractive index Δ₄ (relative to pure silica glass). In these embodiments, the low-index trench 106 and the outer cladding 108 are arranged such that the low-index trench 106 is disposed between the inner cladding 104 and the outer cladding 108 and the inner cladding 104 is disposed between the core 102 and the low-index trench 106. In these embodiments, the outer cladding 108 is in direct contact with the low-index trench 106. In the embodiments described herein, the low-index trench 106 surrounds and is in direct contact with the inner cladding 104. In embodiments where the cladding portion 103 comprises an outer cladding 108 (as depicted in FIGS. 1 and 2), the outer cladding 108 is the outer-most part of the glass portion of the optical fiber 100 (i.e., where the glass portion of the optical fiber 100 comprises the core portion 101 and the cladding portion 103).

In embodiments where the cladding portion 103 does not comprise an outer cladding, the inner cladding 104 is disposed between the core 102 and the low-index trench 106. The low-index trench 106 surrounds and is in direct contact with the inner cladding 104. In embodiments where the cladding portion 103 does not comprise an outer cladding, the low-index trench 106 is the outer-most part of the glass portion of the optical fiber 100 (i.e., where the glass portion of the optical fiber 100 comprises the core portion 101 and the cladding portion 103).

The terms “trench” and “low-index trench,” as used herein, refer to a region of the optical fiber that has a depressed refractive index relative to glass portions of the optical fiber 100 immediately adjacent to the low-index trench 106. For example, in the embodiment of the optical fiber 100 depicted in FIGS. 1 and 2, the low-index trench 106 is positioned between the inner cladding 104 and the outer cladding 108. In this embodiment, the inner cladding 104 is in direct contact with both the core 102 and the low-index trench 106 and the low-index trench 106 is in direct contact with the outer cladding 108. The low-index trench 106 has a depressed refractive index relative to the inner cladding 104 and the outer cladding 108. In this embodiment, Δ₁ₘₐₓ>Δ₄; Δ₃ₘᵢₙ<Δ₂; and Δ₃ₘᵢₙ<Δ₄. In the embodiments described herein, Δ₄ may be equal to Δ₂, Δ₄ may be less than Δ₂, or Δ₄ may be greater than Δ₂, so long as Δ₄ and Δ₂ are greater than Δ₃ₘᵢₙ and Δ₁ₘₐₓ is greater than Δ₄, Δ₂, and Δ₃ₘᵢₙ. In embodiments, Δ₁ₘₐₓ>Δ₂>Δ₃ₘᵢₙ. In embodiments, Δ₁ₘₐₓ>Δ₂>Δ₃ₘᵢₙ, Δ₄≥Δ₂ and Δ₄>Δ₃ₘᵢₙ.

Similarly, in embodiments where the cladding portion 103 does not include an outer cladding, the inner cladding 104 is in direct contact with both the core 102 and the low-index trench 106. In such embodiments, Δ₁ₘₐₓ>Δ₂ and Δ₃ₘᵢₙ<Δ₂. That is, Δ₁ₘₐₓ>Δ₂>Δ₃ₘᵢₙ.

In the embodiments described herein, the core 102, the inner cladding 104, the low-index trench 106, and the outer cladding 108 (when included) are formed from silica-based glass.

Still referring to FIGS. 1 and 2, the core 102 has a radius r₁. The inner cladding 104 surrounds the core 102 and extends from the radius r₁ to the radius r₂ such that the inner cladding 104 has a radial width W₂=r₂−r₁. The low-index trench 106 surrounds the core 102 and the inner cladding 104 and extends from the radius r₂ to the radius r₃ such that the low-index trench 106 has a radial width W₃=r₃−r₂. The outer cladding 108, when included, may surround the low-index trench 106 and extends from the radius r₃ to the radius r₄ such that the outer cladding has a radial width of W₄=r₄−r₃. Accordingly, the glass portion of the optical fiber 100 (e.g., the core 102, the inner cladding 104, the low-index trench 106, and the outer cladding 108) may have a diameter of 2*r₄. In embodiments described herein, the radius r₄ of the glass portion of the optical fiber 100 may be greater than or equal to 40.0 microns to less than or equal to 62.5 microns (i.e., 80.0 microns≤2*r₄≤125.0 microns). However, it is contemplated that the radius r₄ of the glass portion of the optical fiber 100 may be less than 40.0 microns or greater than 62.5 microns depending on the specific application in which the optical fiber 100 is employed.

In embodiments where the cladding portion 103 does not include an outer cladding, the glass portion of the optical fiber 100 (e.g., the core 102, the inner cladding 104, and the low-index trench 106) may have a diameter of 2*r₃. In embodiments, the radius r₃ of the glass portion of the optical fiber 100 (i.e., the core 102, the inner cladding 104, and the low-index trench 106) may be greater than or equal to 40.0 microns to less than or equal to 62.5 microns (i.e., 80.0 microns≤2*r₃≤125.0 microns). However, it is contemplated that the radius r₃ of the glass portion of the optical fiber 100 may be less than 40.0 microns or greater than 62.5 microns depending on the specific application in which the optical fiber 100 is employed.

The radius r₁ of the core 102 is defined as the point at which the line tangent to the maximum slope of the relative refractive index profile (i.e., FIG. 2) of the core 102 crosses the zero delta line (Δ₀). The zero delta line (Δ₀) refers to the line where the relative refractive index Δ % equals 0. In the embodiments of the optical fiber 100 depicted in FIGS. 1 and 2, the radius r₁ of the core 102 is greater than or equal to 5.5 microns and less than or equal to 7.5 microns. In embodiments, the radius r₁ of the core 102 is greater than or equal to 5.7 microns and less than or equal to 7.3 microns, for example greater than or equal to 6.0 microns and less than or equal to 7.0 microns or even greater than or equal to 6.2 microns and less than or equal to 6.8 microns.

In embodiments, the maximum relative refractive index Δ₁ₘₐₓ of the core 102 of the optical fiber 100 is greater than 0.00% and less than or equal to 0.20%. In some embodiments, the maximum relative refractive index Δ₁ₘₐₓ of the core 102 is greater than or equal to 0.10% and less than or equal to 0.15% or even greater than or equal to 0.10% and less than or equal to 0.13%. In some embodiments, the maximum relative refractive index Δ₁ₘₐₓ of the core 102 is greater than or equal to 0.11% and less than or equal to 0.13%.

To obtain maximum relative refractive index Δ₁ₘₐₓ values greater than or equal to 0.10%, the core 102 of the optical fiber 100 may be up-doped with one or more dopants that increase the refractive index of silica glass. Suitable up-dopants include, without limitation, GeO₂, Al₂O₃, P₂O₅, TiO₂, Cl⁻, or the like. For example, the core 102 may be up-doped with greater than or equal to 1.8 wt. % to less than or equal to 3 wt. % GeO₂ to achieve the desired relative refractive index profile in the core 102. As another example, the core 102 may be up-doped with greater than or equal to 1.0 wt. % to less than or equal to 1.5 wt. % Cl⁻ to achieve the desired relative refractive index profile in the core 102.

While up-doping the core may be utilized to generally achieve the desired Δ₁ₘₐₓ values of the relative refractive index of the core 102, it may be desirable to “fine tune” the Δ₁ₘₐₓ value of the core 102 to achieve specific properties for the fiber, including, without limitation, the mode field diameter, bend properties (i.e., bend loss), and fiber core cutoff wavelength of the optical fiber. Fine control of the value of Δ₁ₘₐₓ% may be achieved by controlling the tension applied to the fiber during manufacturing, as described in U.S. Pat. No. 11,530,157 entitled “Method of Manufacturing An Optical Fiber Using Axial Tension Control To Reduce Axial Variations In Optical Properties” and U.S. patent application Ser. No. 16/936,991 entitled “Tension-Based Methods For Forming Bandwidth Tuned Optical Fibers For Bi-Modal Optical Data Transmission.” The techniques disclosed in these references allow for fine control and adjustment of the Δ₁ₘₐₓ value of the fiber to achieve the desired optical properties.

In such embodiments, the Δ₁ₘₐₓ of the core 102 may be “fine tuned” through an iterative process which may include, for example and without limitation: drawing the optical fiber at an initial, nominal applied draw tension (e.g., 80 g of tension); measuring the mode field diameter, fiber core cutoff wavelength, and bend properties of the drawn fiber at the desired wavelengths; based on the measured properties, determining an adjusted draw tension (i.e., an increase or decrease of the nominal applied draw tension) to achieve the desired values for the mode field diameter, fiber core cutoff wavelength, and bend properties of the drawn fiber; and drawing the fiber at the adjusted draw tension. Thereafter, the properties of the fiber may be re-measured and the process iterated until the desired properties of the fiber are obtained.

In the embodiments of the optical fiber 100 described herein, the core 102 of the optical fiber 100 has a relative refractive index profile with a core alpha (a) that is greater than or equal to 2, greater than or equal to 5, greater than or equal to 8, or even greater than or equal to 10. In embodiments the core alpha is less than or equal to 100. In embodiments, core a of the core 102 is greater than or equal to 2 and less than or equal to 100, greater than or equal to 5 and less than or equal to 100, greater than or equal to 8 and less than or equal to 100, or even greater than or equal to 10 and less than or equal to 100. In some embodiments, core a of the core 102 is greater than or equal to 5 and less than or equal to 40 or even greater than or equal to 8 and less than or equal to 40.

Still referring to FIGS. 1 and 2, the inner cladding 104 is directly adjacent to and in direct contact with the core 102. The inner radius of the inner cladding 104 is equal to the radius r₁ of the core 102 and the outer radius of the inner cladding 104 (i.e., the radius r₂ of the inner cladding 104) is defined as the point at which the line tangent to the maximum slope of the relative refractive index profile (i.e., FIG. 2) in the transition region between the inner cladding 104 and the low-index trench 106 crosses the zero delta line (Δ₀). In embodiments, the radius r₂ of the inner cladding 104 is greater than or equal to 12.0 microns, greater than or equal to 13.0 microns, greater than or equal to 14.0 microns, greater than or equal to 15.0 microns, greater than or equal to 16.0 microns, greater than or equal to 17.0 microns, greater than or equal to 18.0 microns, greater than or equal to 19.0 microns, greater than or equal to 20.0 microns, greater than or equal to 21.0 microns, greater than or equal to 22.0 microns, greater than or equal to 23.0 microns, or even greater than or equal to 24.0 microns. In embodiments, the radius r₂ of the inner cladding 104 is greater than or equal to 12.0 microns and less than or equal to 30.0 microns, such as greater than or equal to 13.0 microns and less than or equal to 30.0 microns, greater than or equal to 14.0 microns and less than or equal to 30.0 microns, greater than or equal to 15.0 microns and less than or equal to 30.0 microns, greater than or equal to 16.0 microns and less than or equal to 30.0 microns, greater than or equal to 17.0 microns and less than or equal to 30.0 microns, greater than or equal to 18.0 microns and less than or equal to 30.0 microns, greater than or equal to 19.0 microns and less than or equal to 30.0 microns, greater than or equal to 20.0 microns and less than or equal to 30.0 microns, greater than or equal to 21.0 microns and less than or equal to 30.0 microns, greater than or equal to 22.0 microns and less than or equal to 30.0 microns, greater than or equal to 23.0 microns and less than or equal to 30.0 microns, greater than or equal to 24.0 microns and less than or equal to 30.0 microns, or even greater than or equal to 24.0 microns and less than or equal to 30.0 microns. In embodiments, the radius r₂ of the inner cladding 104 is greater than or equal to 12.0 microns and less than or equal to 29.0 microns, greater than or equal to 12.0 microns and less than or equal to 28.0 microns, greater than or equal to 12.0 microns and less than or equal to 27.0 microns, greater than or equal to 12.0 microns and less than or equal to 26.0 microns, greater than or equal to 12.0 microns and less than or equal to 25.0 microns, greater than or equal to 12.0 microns and less than or equal to 24.0 microns, greater than or equal to 12.0 microns and less than or equal to 23.0 microns, greater than or equal to 12.0 microns and less than or equal to 22.0 microns, greater than or equal to 12.0 microns and less than or equal to 21.0 microns, greater than or equal to 12.0 microns and less than or equal to 20.0 microns, greater than or equal to 12.0 microns and less than or equal to 19.0 microns, greater than or equal to 12.0 microns and less than or equal to 18.0 microns, or even greater than or equal to 12.0 microns and less than or equal to 17.0 microns. In embodiments, the radius r₂ of the inner cladding 104 is greater than or equal to 15.0 microns and less than or equal to 29.0 microns, greater than or equal to 15.0 microns and less than or equal to 28.0 microns, greater than or equal to 15.0 microns and less than or equal to 27.0 microns, greater than or equal to 15.0 microns and less than or equal to 26.0 microns, greater than or equal to 15.0 microns and less than or equal to 25.0 microns, greater than or equal to 15.0 microns and less than or equal to 24.0 microns, greater than or equal to 15.0 microns and less than or equal to 23.0 microns, greater than or equal to 15.0 microns and less than or equal to 22.0 microns, greater than or equal to 15.0 microns and less than or equal to 21.0 microns, greater than or equal to 15.0 microns and less than or equal to 20.0 microns, greater than or equal to 15.0 microns and less than or equal to 19.0 microns, greater than or equal to 15.0 microns and less than or equal to 18.0 microns, or even greater than or equal to 15.0 microns and less than or equal to 17.0 microns. In embodiments, the radius r₂ of the inner cladding 104 is greater than or equal to 15.0 microns and less than or equal to 25.0 microns, greater than or equal to 16.0 microns and less than or equal to 25.0 microns, greater than or equal to 17.0 microns and less than or equal to 25.0 microns, greater than or equal to 18.0 microns and less than or equal to 25.0 microns, greater than or equal to 19.0 microns and less than or equal to 25.0 microns, or even greater than or equal to 20.0 microns and less than or equal to 25.0 microns.

The relative refractive index Δ₂ of the inner cladding 104 is greater than or equal to −0.10% and less than or equal to 0.10%. In embodiments, the relative refractive index Δ₂ of the inner cladding 104 is greater than or equal to −0.10% and less than or equal to 0.00% or even greater than or equal to −0.10% and less than or equal to −0.02%.

In embodiments, the difference of the relative refractive index Δ₁ₘₓ of the core 102 and the relative refractive index Δ₂ of the inner cladding 104 (i.e., Δ₁ₘₓ−Δ₂) is greater than or equal to 0.10% and less than or equal to 0.15%. In some of these embodiments, Δ₁ₘₐₓ−Δ₂ is greater than or equal to 0.11% and less than or equal to 0.14% or even greater than or equal to 0.12% and less than or equal to 0.13%.

Still referring to FIGS. 1 and 2, the low-index trench 106 is directly adjacent to and in direct contact with the inner cladding 104. The inner radius of the low-index trench is equal to the radius r₂ of the inner cladding 104 and the outer radius of the low-index trench 106 (i.e., radius r₃ of the low-index trench 106) is defined as the point at which the line tangent to the maximum slope of the relative refractive index profile (i.e., FIG. 2) in the transition region between the low-index trench 106 and the outer cladding 108 crosses the zero delta line (Δ₀).

In the embodiments depicted in FIGS. 1 and 2 (i.e., where the optical fiber comprises an outer cladding 108), the radius r₃ of the low-index trench 106 is greater than or equal to 15.0 microns which improves the bend performance of the optical fiber 100 and also results in the optical fiber 100 having a fiber core cutoff wavelength of less than 1300 nm, less than 1250 nm, less than 1200 nm, less than 1150 nm, or even less than 1100 nm. In embodiments, the radius r₃ of the low-index trench 106 is greater than or equal to 15.0 microns and less than or equal to 25.0 microns, such as greater than or equal to 16.0 microns and less than or equal to 24.0 microns, greater than or equal to 17.0 microns and less than or equal to 23.0 microns, greater than or equal to 18.0 microns and less than or equal to 22.0 microns, or even greater than or equal to 19.0 microns and less than or equal to 21.0 microns. In embodiments, the radius r₃ of the low-index trench 106 is greater than or equal to 25.0 microns and less than or equal to 35.0 microns, such as greater than or equal to 26.0 microns and less than or equal to 34.0 microns, greater than or equal to 27.0 microns and less than or equal to 33.0 microns, greater than or equal to 28.0 microns and less than or equal to 32.0 microns, or even greater than or equal to 29.0 microns and less than or equal to 31.0 microns.

In embodiments where the optical fiber 100 comprises an outer cladding 108, the radial width W₃ of the low-index trench 106 is greater than or equal to 2.0 microns and less than or equal to 10.0 microns. In embodiments, the radial width W₃ of the low-index trench 106 is greater than or equal to 2.0 microns and less than or equal to 9.0 microns, greater than or equal to 2.0 microns and less than or equal to 8.0 microns, greater than or equal to 2.0 microns and less than or equal to 7.0 microns, or even greater than or equal to 2.0 microns and less than or equal to 6.0 microns. In embodiments, the radial width W₃ of the low-index trench 106 is greater than or equal to 3.0 microns and less than or equal to 10.0 microns, greater than or equal to 4.0 microns and less than or equal to 10.0 microns, greater than or equal to 5.0 microns and less than or equal to 10.0 microns, or even greater than or equal to 6.0 microns and less than or equal to 10.0 microns.

In embodiments where the optical fiber 100 does not include an outer cladding 108, the radius r₃ of the low-index trench 106 is greater than or equal to 40.0 microns which improves the bend performance of the optical fiber 100 and also results in the optical fiber 100 having a fiber core cutoff wavelength of less than 1300 nm, less than 1250 nm, less than 1200 nm, less than 1150 nm, or even less than 1100 nm. In these embodiments, the radius r₃ of the low-index trench 106 is greater than or equal to 40.0 microns and less than or equal to 62.5 microns, such as greater than or equal to 41.0 microns and less than or equal to 62.5 microns, greater than or equal to 42.0 microns and less than or equal to 62.5 microns, greater than or equal to 43.0 microns and less than or equal to 62.5 microns, greater than or equal to 44.0 microns and less than or equal to 62.5 microns, greater than or equal to 45.0 microns and less than or equal to 62.5 microns, greater than or equal to 46.0 microns and less than or equal to 62.5 microns, greater than or equal to 47.0 microns and less than or equal to 62.5 microns, greater than or equal to 48.0 microns and less than or equal to 62.5 microns, greater than or equal to 49.0 microns and less than or equal to 62.5 microns, greater than or equal to 50.0 microns and less than or equal to 62.5 microns, greater than or equal to 51.0 microns and less than or equal to 62.5 microns, greater than or equal to 52.0 microns and less than or equal to 62.5 microns, greater than or equal to 53.0 microns and less than or equal to 62.5 microns, greater than or equal to 54.0 microns and less than or equal to 62.5 microns, or even greater than or equal to 55.0 microns and less than or equal to 62.5 microns.

In embodiments where the optical fiber 100 does not include an outer cladding 108, the radial width W₃ of the low-index trench 106 is greater than or equal to 32.5 microns and less than or equal to 50.5 microns. In embodiments, the radial width W₃ of the low-index trench 106 is greater than or equal to 32.5 microns and less than or equal to 49.5 microns, greater than or equal to 32.5 microns and less than or equal to 48.5 microns, greater than or equal to 32.5 microns and less than or equal to 47.5 microns, greater than or equal to 32.5 microns and less than or equal to 46.5 microns, greater than or equal to 32.5 microns and less than or equal to 47.5 microns, greater than or equal to 32.5 microns and less than or equal to 46.5 microns, greater than or equal to 32.5 microns and less than or equal to 45.5 microns, greater than or equal to 32.5 microns and less than or equal to 44.5 microns, greater than or equal to 32.5 microns and less than or equal to 43.5 microns, greater than or equal to 32.5 microns and less than or equal to 42.5 microns, greater than or equal to 32.5 microns and less than or equal to 41.5 microns, greater than or equal to 32.5 microns and less than or equal to 40.5 microns, greater than or equal to 32.5 microns and less than or equal to 39.5 microns, greater than or equal to 32.5 microns and less than or equal to 38.5 microns, greater than or equal to 32.5 microns and less than or equal to 37.5 microns, or even greater than or equal to 32.5 microns and less than or equal to 36.5 microns.

As noted herein, the minimum relative refractive index Δ3 min of the low-index trench 106 is less than the maximum relative refractive index Δ₁ₘₐₓ of the core 102 and the relative refractive index Δ₂ of the inner cladding 104. In the embodiments described herein, the minimum relative refractive index Δ₃ₘᵢₙ of the low-index trench 106 is generally less than or equal to −0.10% relative to pure, undoped silica. In some embodiments, the minimum relative refractive index Δ₃ₘᵢₙ of the low-index trench 106 is greater than or equal to −0.70% and less than or equal to −0.10%, greater than or equal to −0.70% and less than or equal to −0.15%, greater than or equal to −0.70% and less than or equal to −0.20%, greater than or equal to −0.70% and less than or equal to −0.25%, greater than or equal to −0.70% and less than or equal to −0.30%, greater than or equal to −0.70% and less than or equal to −0.35%, or even greater than or equal to −0.70% and less than or equal to −0.40%. In embodiments, the relative refractive index Δ₃ of the low-index trench 106 is essentially flat. That is, the difference between the relative refractive index Δ₃ at any two radii within the low-index trench 106 is less than 0.03%, or even less than 0.01% (i.e., |Δ₃ₘᵢₙ|−|Δ₃|<0.03%). In other embodiments, the low-index trench 106 may have small fluctuations in the relative refractive index Δ₃ as a result of small profile design or process variations.

The low-index trench 106 may be formed from silica glass that is doped with F⁻ that decreases the index of refraction of the glass of the low-index trench. In embodiments, the low-index trench 106 is formed from silica glass that is down-doped with greater than or equal to 0.7 wt. % and less than or equal to 2.5 wt. % F⁻. In some other embodiments, the low-index trench 106 is formed from silica glass that is down-doped with greater than or equal 5 wt. % and less than or equal to 10 wt. % boron oxide (B₂O₃). Accordingly, it should be understood that the low-index trench 106 is formed from silica glass doped with one or more dopants such that the minimum relative refractive index Δ₃ₘᵢₙ of the low-index trench 106 is greater than or equal to −0.70% and less than or equal to −0.10%.

The radial width of a particular glass portion of an optical fiber may be interrelated with a relative refractive index of the particular glass portion. Specifically, a glass portion ‘i’ with an absolute relative refractive index |Aᵢ| %, an inner radius Rᵢₙ and an outer radius Rₒᵤₜ may have a volume Vᵢ defined as:

$${V}_{i} = 2 {\int }_{{R}_{i n}}^{{R}_{o u t}} \vert {Δ}_{i} \vert \% ( R ) dR$$

which may be rewritten as if |Δᵢ| is constant:

$${V}_{i} = \vert {Δ}_{i} \vert \% ( {R}_{out}^{2} - {R}_{i n}^{2} ) .$$

Accordingly, the low-index trench 106 may have a trench volume V_{T} of:

$${V}_{3} = \vert {Δ}_{3} \vert \% ( {r}_{3}^{2} - {r}_{2}^{2} )$$

To achieve good bend performance, the absolute value of the volume |V_{T}| of the low-index trench 106 is preferably greater than 50% Δmicron² (% Δμm²). In embodiments, the volume |V_{T}| of the low-index trench 106 may be greater than or equal to 50% Δmicron² or even greater than or equal to 55% Δmicron². In embodiments, the volume |V_{T}| of the low-index trench 106 may be greater than or equal to 60% Δmicron² or even greater than or equal to 65% Δmicron². In embodiments, the volume |V_{T}| of the low-index trench 106 may be greater than or equal to 70% Δmicron² or even greater than or equal to 75% Δmicron². In embodiments, the volume |V_{T}| of the low-index trench 106 may be greater than or equal to 80% Δmicron² or even greater than or equal to 85% Δmicron².

In embodiments of the optical fiber 100 comprising an outer cladding 108, the volume |V_{T}| of the low-index trench is greater than or equal to 50% Δmicron² and less than or equal to 150% Δmicron². In embodiments, the volume |V_{T}| of the low-index trench is greater than or equal to 60% Δmicron² and less than or equal to 140% Δmicron². In embodiments, the volume |V_{T}| of the low-index trench is greater than or equal to 60% Δmicron² and less than or equal to 130% Δmicron².

In embodiments of the optical fiber 100 without an outer cladding, the volume |V_{T}| of the low-index trench is greater than or equal to 50% Δmicron² and less than or equal to 900% Δmicron², greater than or equal to 60% Δmicron² and less than or equal to 860% Δmicron² greater than or equal to 70% Δmicron² and less than or equal to 820% Δmicron², greater than or equal to 80% Δmicron² and less than or equal to 780% Δmicron², greater than or equal to 90% Δmicron² and less than or equal to 740% Δmicron², greater than or equal to 100% Δmicron² and less than or equal to 700% Δmicron², greater than or equal to 110% Δmicron² and less than or equal to 700% Δmicron², greater than or equal to 120% Δmicron² and less than or equal to 660% Δmicron², greater than or equal to 130% Δmicron² and less than or equal to 620% Δmicron², greater than or equal to 140% Δmicron² and less than or equal to 580% Δmicron², or even greater than or equal to 160% Δmicron² and less than or equal to 560% Δmicron².

Still referring to FIGS. 1 and 2, the outer cladding 108 (when included) is directly adjacent to and in direct contact with the low-index trench 106. The inner radius of the outer cladding 108 is equal to the radius r₃ of the low-index trench 106 and the outer radius of the outer cladding 108 (i.e., radius r₄ of the outer cladding 108) corresponds to the outer radius of the glass portion of the optical fiber. In embodiments, the radius r₄ of the glass portion of the optical fiber is greater than or equal to 40 microns and less than or equal to 62.5 microns (i.e., 2*r₄ is greater than or equal to 80 μm and less than or equal to 125 μm).

As noted herein, the outer cladding 108 has a relative refractive index Δ₄ that is greater than the relative refractive index Δ₃ of the low-index trench 106, thereby forming a region that is “up-doped” relative to the low-index trench 106. To achieve this index differential, the outer cladding 108 is formed from pure, undoped silica glass or silica glass that includes an amount of up-dopant sufficient to increase the refractive index of the silica glass of the outer cladding 108. In embodiments described herein, the up-dopant in the outer cladding 108 may be up-doped with one or more dopants that increase the refractive index of silica glass. Suitable up-dopants include, without limitation, GeO₂, Al₂O₃, P₂O₅, TiO₂, Cl⁻, or the like. For example, the outer cladding 108 may be up-doped with greater than 0.0 wt. % to less than or equal to 1.8 wt. % GeO₂ or even greater than 0.0 wt. % to less than or equal to 1.0 wt. % GeO₂ to achieve the desired relative refractive index profile in the outer cladding 108. For example, the outer cladding 108 may be up-doped with greater than 0.0 wt. % to less than or equal to 1.0 wt. % Cl⁻ or even greater than 0.0 wt. % to less than or equal to 0.5 wt. % Cl⁻ to achieve the desired relative refractive index profile in the outer cladding 108.

In embodiments, the relative refractive index Δ₄ of the outer cladding 108 is greater than or equal to 0.00% and less than or equal to 0.50%. For example, in some embodiments, the relative refractive index Δ₄ of the outer cladding 108 is greater than or equal to 0.10% and less than or equal to 0.50% or even greater than or equal to 0.10% and less than or equal to 0.30%. In some of these embodiments, the relative refractive index Δ₄ of the outer cladding 108 is greater than or equal to 0.15% and less than or equal to 0.30%.

Still referring to FIGS. 1-2, in embodiments, the core 102 of the optical fiber 100 may comprise a relative refractive index profile having a so-called centerline dip that may occur as a result of one or more optical fiber manufacturing techniques. However, the centerline dip in any of the refractive index profiles disclosed herein is optional.

The glass portion of the optical fibers disclosed herein may be surrounded by a protective coating, e.g. a primary coating (not shown) contacting and surrounding the outer cladding 108. In embodiments, the primary coating may have a Young's modulus of less than 1.0 MPa, less than 0.9 MPa, or even less than 0.8 MPa. In embodiments, the optical fiber may further comprise a secondary coating (not shown) contacting and surrounding the primary coating. In embodiments, the secondary coating may have a Young's modulus of greater than 1200 MPa or even greater than 1400 MPa.

In embodiments in which the optical fiber 100 comprises primary and secondary coatings, the outer diameter of the secondary coating is less than 250 microns. In embodiments, the outer diameter of the secondary coating is less than 200 microns.

As used herein, the Young's modulus of a cured polymeric material of a primary coating is measured using a tensile testing instrument (e.g., a Sintech MTS Tensile Tester, or an INSTRON Universal Material Test System) on a sample of a material shaped as a film between about 0.003″ (76 micron) and 0.004″ (102 micron) in thickness and about 1.3 cm in width, with a gauge length of 5.1 cm, and a test speed of 2.5 cm/min.

Additional description of suitable primary and secondary coatings can be found in PCT Publication WO2005/010589, which is incorporated herein by reference in its entirety.

In embodiments, the optical fiber 100 has a mode field diameter at a wavelength of 1310 nm (MFD₁₃₁₀) greater than or equal to 12.0 microns and less than or equal to 16.0 microns. MFDs within this range match substantially the MFDs of the fundamental modes of 50.0 micron and 62.5 micron multimode fibers at 1310 nm, therefore enabling light coupling to the fundamental mode of the multimode fibers with minimal loss to reduce multipath interference (MPI) effects. In embodiments, MFD₁₃₁₀ is greater than or equal to 12.5 microns and less than or equal to 15.5 microns. In embodiments, MFD₁₃₁₀ is greater than or equal to 13.0 microns and less than or equal to 15.0 microns. In embodiments, MFD₁₃₁₀ is greater than or equal to 13.5 microns and less than or equal to 14.5 microns.

In embodiments, the optical fiber 100 has a mode field diameter at a wavelength of 1550 nm (MFD₁₅₅₀) greater than or equal to 14.0 microns and less than or equal to 18.0 microns. In embodiments, MFD₁₅₅₀ is greater than or equal to 14.5 microns and less than or equal to 17.5 microns. In embodiments, MFD₁₅₅₀ is greater than or equal to 14.5 microns and less than or equal to 17.0 microns. In embodiments, MFD₁₅₅₀ is greater than or equal to 15.0 microns and less than or equal to 17.0 microns. In embodiments, MFD₁₅₅₀ is greater than or equal to 15.5 microns and less than or equal to 17.0 microns. In embodiments, MFD₁₅₅₀ is greater than or equal to 15.5 microns and less than or equal to 16.5 microns.

Embodiments of the optical fibers described herein exhibit a macrobend bend loss that is less than 0.5 dB/turn at 1310 nm when the optical fiber is wound around a 30 mm diameter mandrel. In embodiments, the 30 mm diameter bend loss at 1310 nm is less than or equal to 0.45 dB/turn, less than or equal to 0.40 dB/turn, less than or equal to 0.35 dB/turn, less than or equal to 0.30 dB/turn, less than or equal to 0.25 dB/turn, less than or equal to 0.20 dB/turn, less than or equal to 0.15 dB/turn, or even less than or equal to 0.10 dB/turn.

Embodiments of the optical fibers described herein exhibit a macrobend bend loss that is less than 2.00 dB/turn at 1550 nm when the optical fiber is wound around a 30 mm diameter mandrel. In other embodiments, the 30 mm diameter bend loss at 1550 nm is less than or equal to 1.50 dB/turn, less than or equal to 1.00 dB/turn, less than or equal to 0.85 dB/turn, less than or equal to 0.80 dB/turn, less than or equal to 0.75 dB/turn, less than or equal to 0.70 dB/turn, less than or equal to 0.65 dB/turn, less than or equal to 0.6 dB/turn, less than or equal to 0.55 dB/turn, less than or equal to 0.50 dB/turn, less than or equal to 0.45 dB/turn, less than or equal to 0.40 dB/turn, less than or equal to 0.35 dB/turn, less than or equal to 0.30 dB/turn, less than or equal to 0.25 dB/turn, less than or equal to 0.20 dB/turn, less than or equal to 0.15 dB/turn, or even less than or equal to 0.10 dB/turn.

Embodiments of the optical fibers described herein exhibit a macrobend bend loss that is less than 1.00 dB/turn at 1310 nm when the optical fiber is wound around a 20 mm diameter mandrel. In embodiments, the 20 mm diameter bend loss at 1310 nm is less than or equal to 0.95 dB/turn, less than or equal to 0.90 dB/turn, less than or equal to 0.85 dB/turn, less than or equal to 0.80 dB/turn, less than or equal to 0.75 dB/turn, less than or equal to 0.70 dB/turn, less than or equal to 0.65 dB/turn, less than or equal to 0.60 dB/turn, less than or equal to 0.55 dB/turn, less than or equal to 0.50 dB/turn, less than or equal to 0.45 dB/turn, less than or equal to 0.40 dB/turn, less than or equal to 0.35 dB/turn, less than or equal to 0.30 dB/turn, less than or equal to 0.25 dB/turn, less than or equal to 0.20 dB/turn, less than or equal to 0.15 dB/turn, or even less than or equal to 0.10 dB/turn.

Embodiments of the optical fibers described herein exhibit a macrobend bend loss that is less than 3.50 dB/turn at 1550 nm when the optical fiber is wound around a 20 mm diameter mandrel. In other embodiments, the 20 mm diameter bend loss at 1550 nm is less than or equal to 3.00 dB/turn, less than or equal to 2.50 dB/turn, less than or equal to 2.00 dB/turn, less than or equal to 1.50 dB/turn, less than or equal to 1.00 dB/turn, less than or equal to 0.85 dB/turn, less than or equal to 0.80 dB/turn, less than or equal to 0.75 dB/turn, less than or equal to 0.70 dB/turn, less than or equal to 0.65 dB/turn, less than or equal to 0.60 dB/turn, less than or equal to 0.55 dB/turn, less than or equal to 0.50 dB/turn, less than or equal to 0.45 dB/turn, less than or equal to 0.40 dB/turn, less than or equal to 0.35 dB/turn, less than or equal to 0.30 dB/turn, less than or equal to 0.25 dB/turn, less than or equal to 0.20 dB/turn, less than or equal to 0.15 dB/turn, or even less than or equal to 0.10 dB/turn.

Embodiments of the optical fibers described herein exhibit fiber core cutoff wavelengths of less than or equal to 1300 nm so that only the fundamental mode LP01 is guided in the core portion of the optical fiber. In embodiments, the fiber core cutoff wavelength of the optical fiber may be less than or equal to 1275 nm, less than or equal to 1250 nm, less than or equal to 1225 nm, less than or equal to 1200 nm, less than or equal to 1175 nm, less than or equal to 1150 nm, less than or equal to 1125 nm, or even less than or equal to 1100 nm.

The foregoing properties of the optical fiber 100 may be measured on segments of optical fiber having lengths as specified for each measurement (i.e., prior to segmenting the fiber into shorter lengths for incorporation into optical transceiver equipment with relatively compact packaging form factors). In embodiments, the optical fiber incorporated into the optical transceiver equipment may have lengths from greater than or equal to 1.0 cm to less than or equal to 10.0 cm. For example, in embodiments, the optical fiber may have a length from greater than or equal to 2.0 cm to less than or equal to 8.0 cm or even greater than or equal to 3.0 cm to less than or equal to 6.0 cm.

The optical fibers disclosed herein may be drawn from optical fiber preforms made using conventional manufacturing techniques, for example, as disclosed in U.S. Pat. Nos. 7,844,155, 9,778,413, 9,873,629, 7,680,381, and 8,428,415, and using known fiber draw methods and apparatuses, for example, as is disclosed in U.S. Pat. Nos. 7,565,820, 5,410,567, 7,832,675, 6,027,062, the specifications of which is hereby incorporated by reference.

### EXAMPLES

The embodiments described herein will be further clarified by the following examples.

Table 1 includes 8 examples of modal-conditioning, single-mode optical fibers as described herein (i.e., Examples 2-9) and one example of a conventional modal-conditioning optical fiber (i.e., Comparative Example 1). Each of Examples 1-9 were modeled using software to determine the properties of the optical fiber designs (i.e., fiber core cutoff wavelength, mode field diameter, and bend loss) at the indicated wavelengths. Comparative Example 1 was modeled with a step-index core having an alpha profile with a core alpha (α) 20 and an outer cladding surrounding and in direct contact with the core (i.e., the fiber of Example 1 did not include an inner cladding or a low-index trench). The outer cladding was modeled with a relative refractive index of 0.00% (i.e., the outer cladding was modeled as being formed from pure (un-doped) silica glass). Examples 2-9 were modeled with a core portion comprising a core and an inner cladding and a cladding portion comprising a low-index trench and an outer cladding, as described herein. The properties of each of the modeled fibers are provided in Table 1.

TABLE 1

| Example | 1 (comp) | 2 | 3 | 4 | 5 | 6 | 7 | 8 | 9 |
|---|---|---|---|---|---|---|---|---|---|
| Δ₁ₘₐₓ (%) | 0.13 | 0.127 | 0.117 | 0.12 | 0.123 | 0.13 | 0.102 | 0.107 | 0.132 |
| r₁ (μm) | 6 | 6.2 | 5.7 | 6.2 | 6.1 | 7.2 | 6.2 | 6.5 | 6.7 |
| Core alpha | 20 | 15 | 15 | 10 | 15 | 15 | 15 | 15 | 15 |
| Δ₂ (%) | n/a | 0.00 | 0.00 | 0.00 | 0.00 | 0.00 | −0.02 | −0.02 | 0.00 |
| r₂ (μm) | n/a | 15.0 | 14.0 | 13.0 | 14.0 | 12.0 | 13.7 | 13.7 | 13.7 |
| r₃ (μm) | n/a | 20.0 | 20.0 | 20.0 | 20.0 | 20.0 | 20.0 | 20.0 | 20.0 |
| Δ₃ₘᵢₙ (%) | n/a | −0.40 | −0.30 | −0.35 | −0.35 | −0.35 | −0.40 | −0.40 | −0.40 |
| \|V_{T}\| (%Δμm²) | n/a | 70 | 61.2 | 80.85 | 71.4 | 89.6 | 80.68 | 80.68 | 84.929 |
| Δ₄ (%) | 0.00 | 0.00 | 0.00 | 0.00 | 0.00 | 0.00 | 0.00 | 0.00 | 0.02 |
| Fiber Core Cutoff | 1096 | 1102 | 975 | 1039 | 1067 | 1291 | 1080 | 1153 | 1212 |
| Wavelength (nm) | | | | | | | | | |
| MFD_{1310 nm} (μm) | 14.1 | 14.0 | 14.1 | 13.9 | 14.0 | 13.9 | 14.0 | 14.0 | 13.9 |
| MFD_{1550 nm} (μm) | 16.6 | 15.8 | 16.0 | 15.4 | 15.6 | 15.0 | 15.6 | 15.5 | 15.3 |
| 20 mm Bend loss at | 245.02 | 0.217 | 0.656 | 0.09288 | 0.242 | 0.0178 | 0.0884 | 0.0716 | 0.050244 |
| 1310 nm (dB/turn) | | | | | | | | | |
| 20 mm Bend loss at | 173.4 | 1.255 | 2.85 | 0.544 | 1.226 | 0.154 | 0.5838 | 0.477 | 0.3218 |
| 1550 nm (dB/turn) | | | | | | | | | |
| 30 mm B loss at 1310 | 74.65 | 0.0954 | 0.265 | 0.052 | 0.0785 | 0.0084 | 0.041 | 0.032 | 0.0194 |
| nm (dB/turn) | | | | | | | | | |
| 30 mm Bend loss at | 235.4 | 0.697 | 1.793 | 0.368 | 0.561 | 0.085 | 0.3869 | 0.325 | 0.1816 |
| 1550 nm (dB/turn) | | | | | | | | | |

The modeled fiber of comparative Example 1 had a mode field diameter at a wavelength of 1310 nm of approximately 14.1 μm and fiber core cutoff of 1096 nm. However, the fiber of comparative Example 1 had poor bending properties relative to the fibers of Examples 2-9. In particular, at a bend diameter of 30 mm, the fiber of comparative Example 1 had a bending loss of 75 dB/turn and 235 dB/turn at wavelengths of 1310 nm and 1550 nm, respectively.

The optical fibers of Examples 2-5 included a low-index trench (such as a low-index trench comprising fluorine to down-dope the glass, as described herein) to enhance the bend performance. In these examples, the low-index trench was spaced apart from the core by the inner cladding to maintain a MFD of approximately 14.0 μm (+/−0.1 μm). In these examples, the low-index trench started at 12.0-14.0 μm (i.e., r₂=12.0-14.0 μm) and ended at 20.0 μm (i.e., r₃=20.0 μm). The optical fibers of Examples 2-5 had fiber core cutoff wavelengths of less than 1150 nm. In these examples, the core delta (Δ₁ₘₐₓ%) was less than conventional, standard single mode fiber, which have core deltas between 0.30% and 0.45%. In particular, Δ₁ₘₐₓ% of Examples 2-5 was less than 0.15%. These values of Δ₁ₘₐₓ% in Examples 2-5 facilitate relatively large MFDs. Δ₁ₘₐₓ % values within the narrow range of Δ₁ₘₐₓ% between 0.12% and 0.13% resulted in enhanced bend performance but higher cutoff wavelengths. The selection of Δ₁ₘₐₓ% values in the design of the optical fiber may be used to balance fiber core cutoff wavelength and bend performance. That is, the Δ₁ₘₐₓ% values of the optical fiber may be selected to achieve both the desired fiber core cutoff wavelength for the optical fibers and the desired bend performance for the optical fibers.

For the optical fibers of Examples 2-5, the bend properties were calculated at 20 mm and 30 mm bend diameters for wavelengths of 1310 nm and 1550 nm. At 1310 nm and a 30 mm bend diameter, the bend losses of the optical fibers of Examples 2-5 were between 0.05 dB/turn and 0.265 dB/turn. As shown in Table 1, Example 3 had the lowest Δ₁ₘₐₓ% of 0.117% and the highest bend loss of 0.265 dB/m. Overall, the improvement in bend loss relative to the optical fiber of comparative Example 1 is more than a factor of 280 for 30 mm bend diameters at a wavelength of 1310 nm. With slightly higher Δ₁ₘₐₓ% values and larger trench volumes |V_{T}|, the optical fibers of Examples 2, 4, and 5 were able to achieve better bend performance relative to the optical fiber of Example 3.

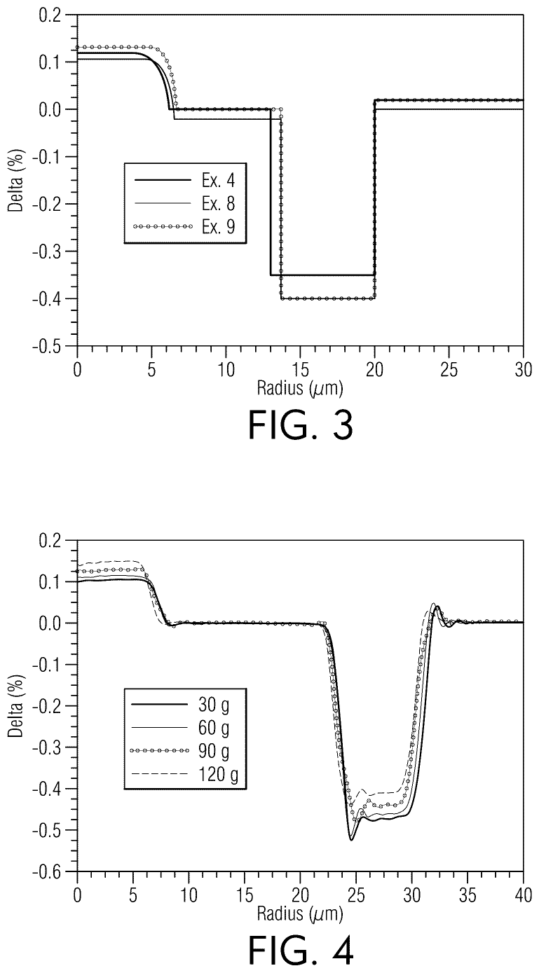

The optical fibers of Examples 6-9 were developed to further improve the bend properties of the optical fibers. For example, the optical fiber of Example 6 was modeled with a Δ₁ₘₐₓ % of 0.13% and a low-index trench starting at a radius r₂ of 12.0 mm with a trench volume |V_{T}| of 80% Δμm². This design had significantly improved bend performance relative to the optical fibers of Examples 2-5. However, the fiber core cutoff wavelength was somewhat elevated. The optical fibers of Examples 7 and 8 were modeled with a down-doped inner cladding between r₁ and r₂, such as when the inner cladding is down-doped with fluorine. The down-doped inner cladding assisted in stripping out higher order modes (i.e., modes higher than the fundamental mode) of an optical signal propagating through the optical fiber that, in turn, lowers the fiber core cutoff wavelength. The optical fibers of Examples 7 and 8 had the desired mode field diameters at wavelengths of 1310 and 1550 nm, and the fiber core cutoff wavelength was lower than that of the optical fiber of Example 6. Fiber 9 was an alternative design to Fiber 8 without using down-doping in the inner cladding, instead using up-doping in the outer cladding, such as when the outer cladding is up-doped with GeO₂ or Cl⁻. The relative refractive index profiles as a function of fiber radius for Fibers 4, 8 and 9 are graphically depicted in FIG. 3 for comparison.

As indicated in the Examples of Table 1, slight variations in the relative refractive index of the core (Δ₁ₘₐₓ%) can change the bend properties and fiber core cutoff wavelengths significantly, indicating that fine control of Δ₁ₘₐₓ% during manufacture of the optical fiber may be utilized to achieve the desired properties in the resulting optical fiber. As noted herein, such fine control of the value of Δ₁ₘₐₓ% may be achieved by controlling the tension applied to the optical fiber during manufacturing, as described in U.S. Pat. No. 11,530,157 entitled “Method of Manufacturing An Optical Fiber Using Axial Tension Control To Reduce Axial Variations In Optical Properties” and U.S. patent application Ser. No. 16/936,991 entitled “Tension-Based Methods For Forming Bandwidth Tuned Optical Fibers For Bi-Modal Optical Data Transmission.” The disclosed techniques allow for fine control and adjustment of the Δ₁ₘₐₓ % value of the optical fiber to achieve the desired optical properties.

Referring now to Table 2 and FIG. 4 by way of example, four optical fibers were drawn at different draw tensions to demonstrate the effect of draw tension on the properties of the resulting optical fibers. The properties of each optical fiber are listed in Table 2 below and the relative refractive index of the optical fibers are depicted in FIG. 4 as a function of the radius of the optical fiber. In particular, the optical fiber of Example 10 was drawn with a draw tension of 30 grams, the optical fiber of Example 11 was drawn with a draw tension of 60 grams, the optical fiber of Example 12 was drawn with a draw tension of 90 grams, and the optical fiber of Example 13 was drawn with a draw tension of 120 grams.

TABLE 2

| Example | 10 | 11 | 12 | 13 |
|---|---|---|---|---|
| Draw Tension (g) | 30 | 60 | 90 | 120 |
| MFD_{1310 nm} (μm) | 14.37 | 14.13 | 13.74 | 13.11 |
| MFD_{1550 nm} (μm) | 17.03 | 16.88 | 16.61 | 14.97 |
| Fiber core cutoff wavelength | 1230 | 1270 | 1323 | 1312 |
| (nm) | | | | |
| 20 mm Bend loss at 1310 nm | 0.34 | 0.41 | 0.57 | 0.33 |
| (dB/turn) | | | | |
| 20 mm Bend loss at 1550 nm | 0.66 | 1.53 | 1.63 | 0.49 |
| (dB/turn) | | | | |
| 30 mm Bend loss at 1310 nm | 0.066 | 0.14 | 0.22 | 0.02 |
| (dB/turn) | | | | |
| 30 mm Bend loss at 1550 nm | 0.20 | 0.18 | 0.30 | 0.01 |
| (dB/turn) | | | | |

As shown in Table 2 and FIG. 4, the relative refractive index Δ₁ₘₐₓ% of the core of the optical fibers increased with increasing draw tension, indicating that the Δ₁ₘₐₓ % values can be finely adjusted with changes to the draw tension. It is also noted that the depth of the low-index trench of the optical fibers decreased with increasing draw tension. The variation in Δ₁ₘₐₓ% with changing draw tension demonstrates that the properties of the optical fiber (i.e., the mode field diameter, bend properties, and fiber core cutoff) may be further adjusted and tuned utilizing the draw tension.

In that regard, the optical properties of the optical fibers of Examples 10-13 were measured as described herein. The optical properties are listed in Table 2. As indicated in Table 2, all four optical fibers have a MFD within 1 micron of the targeted 14.0 micron value at a wavelength of 1310 nm. Further, each of the optical fibers of Examples 10-13 showed good bend performance at both 1300 nm and 1500 nm at a bend radius of 30 mm and fiber core cutoff wavelength of around 1200 nm.

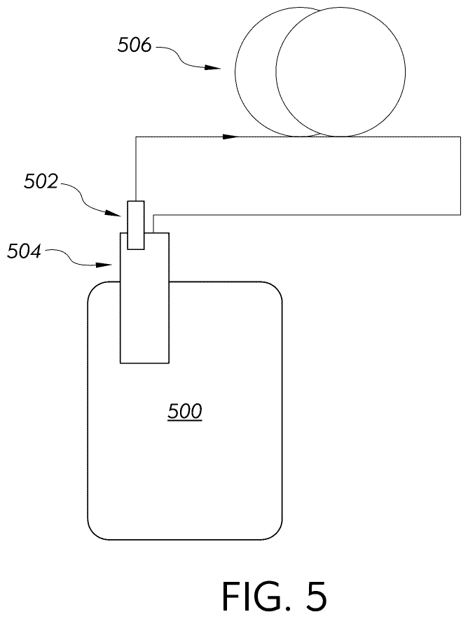

Referring now to FIG. 5, further experiments were conducted to assess performance of the optical fibers for use in a transceiver package. In particular, segments of the optical fiber of Example 11 were prepared in two conditions: one fiber was prepared as a short jumper with LC connectors and a length of 6-7 cm; a second fiber having a length of approximately 1 cm was prepared in a single mode fiber (SMF) adapter form factor (i.e., and LC connector). FIG. 5 schematically depicts the experimental setup. In particular, a Viavi Optical Network Tester (ONT) 500 was used. The ONT 500 was either a Model ONT-603 (for 100G testing) or a Model ONT-804 (for 400G testing). The short jumper comprising the fiber of Example 11 or the SMF adapter comprising the fiber of Example 11 was used as a mode-matching device 502 to couple the output of an optical transceiver 504 to one end of a length of multimode fiber 506. The other end of the multimode fiber 506 was connected to the input of the optical transceiver 504. The multimode fiber 506 was OM2 fiber with a length of approximately 1 km. The optical transceiver 504 was, in turn, coupled to the ONT 500. The optical transceiver 504 was either an Intel 100G CWDM4 transceiver (for 100G testing) or an Intel 400G LR4 transceiver (for 400G testing). Both transceivers were single mode transceivers using four wavelengths around 1310 nm and included duplex LC connector ports.

In all testing conditions, (i.e., 100G testing or 400G testing with either the short jumper or the SMF adapter configurations) the test system performed without error, meaning single mode performance was maintained when launching a single mode optical signal into the multimode fiber through the mode matching device 502. Single mode performance at the output of the multimode fiber 506 was validated with the ONT 500. In particular, the testing confirmed that single mode transmission was maintained through the multimode fiber 506 using the mode matching device 502 with the SMF adapter configuration including an approximately 1 cm length of the MC-SMF fiber. Similarly, the testing confirmed that single mode transmission was maintained through the multimode fiber 506 using the mode-matching device 502 with the MC-SMF in the short jumper configuration. Testing of this configuration also confirmed that the short jumper could be bent to a 2-3 cm bending diameter while still maintaining its transmission characteristics (i.e., no significant bend loss was observed) indicating that the MC-SMF could be readily deployed within a transceiver package and bent without a decrease in performance.

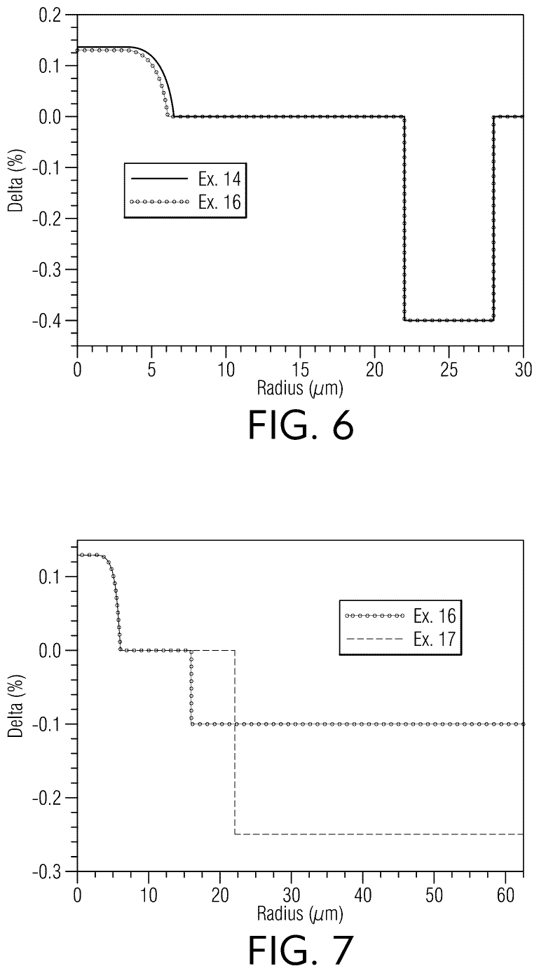

Referring now to Table 3 and FIGS. 6 and 7, Table 3 includes four additional examples of modal-conditioning, single mode optical fibers according to embodiments described herein. In particular, each of Examples 14-17 were modeled using software to determine the properties of the optical fiber designs (i.e., fiber core cutoff, mode field diameter, and bend loss) at the indicated wavelengths. Examples 14 and 15 were modeled with a core portion comprising a core and an inner cladding and a cladding portion comprising a low-index trench and an outer cladding, as described herein. The radius of the core and relative refractive index Δ₁ₘₐₓ% of the core was varied between Example 14 and Example 15. The remaining portions of the optical fibers of Example 14 and Example 15 were substantially the same. Examples 16 and 17 were modeled with a core portion comprising a core and an inner cladding and a cladding portion comprising only a low-index trench (i.e., Examples 16 and 17 did not include an outer cladding and, as such, the radius r₃ of the low-index trench was co-extensive with the radius of the glass portion of the optical fiber) as described herein. The value of Δ₃ₘᵢₙ % was varied between Example 16 and Example 17 and, accordingly the volume |V_{T}| of the low-index trench. The remaining portions of the optical fibers of Example 16 and Example 17 were substantially the same. The relative refractive index profiles of the fibers of Example 14 and 15 are graphically depicted in FIG. 6. The relative refractive index profiles of the fibers of Example 16 and 17 are graphically depicted in FIG. 7. The optical properties of each of the modeled fibers are provided in Table 3.

TABLE 3

| Example | 14 | 15 | 16 | 17 |
|---|---|---|---|---|
| Δ₁ (%) | 0.135 | 0.13 | 0.13 | 0.13 |
| r₁ (μm) | 6.2 | 6.0 | 6.0 | 6.0 |
| Core alpha | 8 | 8 | 8 | 8 |
| Δ₂ (%) | 0.00 | 0.00 | 0.00 | 0.00 |
| r₂ (μm) | 22.0 | 22.0 | 15.0 | 22.0 |
| r₃ (μm) | 28.0 | 28.0 | 62.5 | 62.5 |
| Δ_{3 min} (%) | −0.40 | −0.40 | −0.15 | −0.25 |
| \|V_{T}\| (% Δμm²) | 120 | 120 | 552 | 855 |
| Δ₄ (%) | 0 | 0 | n/a | n/a |
| Fiber Core Cutoff | 1077 | 1024 | 1024 | 1024 |
| Wavelength (nm) | | | | |
| MFD_{1310 nm} (μm) | 13.99 | 14.19 | 13.94 | 14.18 |
| MFD_{1550 nm} (μm) | 16.42 | 16.81 | 16.06 | 16.84 |
| 20 mm Bend loss at | 1.00 | 0.79 | 0.92 | 4.0E−03 |
| 1310 nm (dB/turn) | | | | |
| 20 mm Bend loss at | 2.21 | 3.03 | 3.40 | 2.5E−02 |
| 1550 nm (dB/turn) | | | | |
| 30 mm Bend loss at | 0.08 | 0.21 | 7.0E−04 | 2.2E−06 |
| 1310 nm (dB/turn) | | | | |
| 30 mm Bend loss at | 0.44 | 1.13 | 2.5E−02 | 1.9E−06 |
| 1550 nm (dB/turn) | | | | |

The modeled data indicates that slight variations in the dimensions and relative refractive index profiles of the optical fibers, as described herein, may be made while still achieving the desired optical properties of the optical fiber (i.e., the mode field diameter, bend properties (i.e., bend loss), and fiber cutoff wavelength).

Further, the example optical fibers in Table 4 were modeled with a low-index trench spaced from the core by the inner cladding by a relatively large distance (i.e., greater than 20 microns) and/or a low-index trench with a relatively large radially width (i.e., greater than 30 microns) such that the optical fibers behave similar to double-clad fibers. That is, the core portions of these fibers (i.e., the core and the inner cladding) theoretically support propagation of the LP11 mode of an optical signal. However, it is not believed that the LP11 mode of an optical signal will be excited for LP01 transmission over a connected multimode fiber. In each of Examples 14-17, the fiber core cutoff was determined to be less than 1100 nm. Without wishing to be bound by theory, it is expected that fibers with a fiber core cutoff of less than 1300 nm, such as the fibers of Examples 14-17, will facilitate LP01 modal transmission of an optical signal introduced into the optical fiber.

As noted herein, the modal-conditioning, single-mode fibers enable LP01 transmission over 50.0 micron core diameter and 62.5 micron core diameter MMF. In that regard, the optical fibers disclosed herein facilitate launching and propagating the fundamental mode of an optical signal emitted by an optical transceiver into the MMF of a legacy local area network and, as such, may be incorporated into an optical transceiver. Moreover, the bend properties of the modal-conditioning, single-mode fibers make the fibers well suited for incorporation into an optical transceiver having a package with a relatively small form factor.

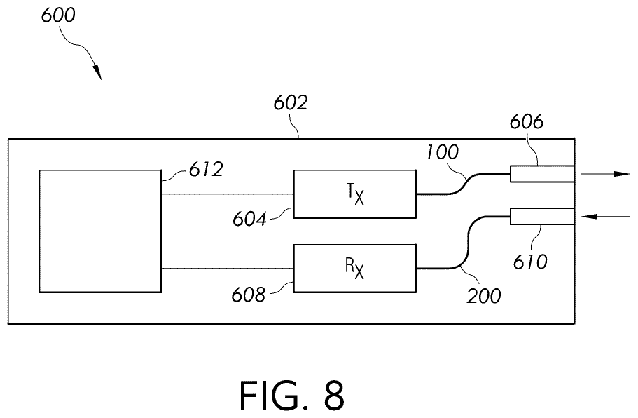

Referring to FIG. 8 by way of example, an optical transceiver 600 comprising a modal-conditioning, single-mode fiber 100 as described herein is schematically depicted. In embodiments, the optical transceiver 600 comprises a housing 602, at least one transmitter 604, at least one receiver 608, and control circuitry 612. The transmitter 604, the receiver 608, and the control circuitry are positioned in the housing 602. The transmitter 604 and the receiver 608 are communicatively coupled to the control circuitry 612. The transmitter 604 is optically coupled to an output receptacle 606 with a MC-SMF 100 having the structure and optical properties described herein. In embodiments, the MC-SMF 100 may define a non-linear optical path between the transmitter 604 and the output receptacle 606, such as when the MC-SMF 100 has at least one bend between the transmitter 604 and the output receptacle 606. In embodiments, the receiver 608 may be coupled to an input receptacle 610 with an optical fiber 200. In embodiments, the optical fiber 200 may have the same structure as the MC-SMF 100. In embodiments, the optical fiber 200 may have a different structure than the MC-SMF 100. In embodiments, the optical fiber 200 may define a non-linear optical path between the receiver 608 and the input receptacle 610, such as when the optical fiber 200 has at least one bend between the receiver 608 and the input receptacle 610.

In operation, an optical signal is emitted from the transmitter and launched into the MC-SMF 100. As the optical signal propagates through the MC-SMF 100, the properties of the MC-SMF 100 (i.e., the MFD of the MC-SMF 100 and the fiber core cutoff wavelength of the MC-SMF 100) condition the optical signal such that only a fundamental mode of the optical signal (i.e., an LP01 mode) is emitted from the output receptacle 606. As described, the MC-SMF 100 may have one or more bends within the housing 602 of the optical transceiver 600. However, the design of the MC-SMF 100 (specifically the incorporation of a low-index trench in the MC-SMF 100) mitigates attenuation of the optical signal due to the bends in the MC-SMF 100.

In embodiments, the output receptacle 606 may be optically coupled to MMF of a local network (not depicted). Because the MC-SMF 100 conditions the optical signal emitted from the transmitter 604, the optical signal emitted from the output receptacle of the optical transceiver 600 is able to propagate in the fundamental mode of the MMF of the local area network. In embodiments, the optical transceiver 600 may receive optical signals from the local network through the input receptacle 610. These signals are propagated to the receiver 608 through the optical fiber 200.

While FIG. 8 schematically depicts an optical transceiver 600 with one transmitter 604 and one receiver 608, it should be understood that the optical transceiver 600 may be constructed with a plurality of transmitters 604 and/or a plurality of receivers 608. In such embodiments, each transmitter 604 may be optically coupled to a corresponding output receptacle 606 with an MC-SMF 100. Similarly, each receiver 608 may be optically coupled to a corresponding input receptacle 610 with an optical fiber 200 that may be, in embodiments, an MC-SMF.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A modal-conditioning, single-mode fiber (MC-SMF) comprising:
a core portion comprising a core and an inner cladding surrounding and directly contacting the core, wherein:
the core comprises an outer radius r₁ and a maximum relative refractive index Δ₁ₘₐₓ relative to undoped silica glass; and
the inner cladding comprises an outer radius r₂ and a relative refractive index Δ₂ relative to undoped silica glass; and
a cladding portion surrounding the core portion, the cladding portion comprising a low-index trench surrounding and directly contacting the inner cladding, the low-index trench comprising an outer radius r₃ and a minimum relative refractive index Δ₃ₘᵢₙ relative to undoped silica glass, wherein:
r₂ is greater than 12.0 μm;
$${Δ}_{1 max} > {Δ}_{2} > {Δ}_{3 min} ;$$
the MC-SMF comprises a mode field diameter MFD greater than or equal to 12.0 μm and less than or equal to 16.0 μm at a wavelength of 1310 nm; and
the MC-SMF comprises a 30 mm diameter bend loss of less than or equal to 0.50 dB/turn at 1310 nm.

2. The MC-SMF of claim 1, wherein Δ₁ₘₐₓ is greater than or equal to 0.10% and less than or equal to 0.15%.

3. The MC-SMF of claim 1, wherein r₁ is greater than or equal to 5.5 μm and less than or equal to 7.5 μm.

4. The MC-SMF of claim 1, wherein the core has a relative refractive index profile with an alpha value greater than or equal to 5.

5. The MC-SMF of claim 1, wherein Δ₂ is greater than or equal to −0.10% and less than or equal to 0.10%.

6. The MC-SMF of claim 1, wherein r₂ is greater than 15.0 μm and less than or equal to 30.0 μm.

7. The MC-SMF of claim 1, wherein Δ₁ₘₐ−Δ₂ is greater than or equal to 0.10% and less than or equal to 0.15%.

8. The MC-SMF of claim 1, wherein Δ₃ₘᵢₙ is greater than or equal to −0.70% and less than or equal to −0.10%.

9. The MC-SMF of claim 1, wherein the low-index trench has a radial width equal to r₃-r₂ and r₃−r₂ is greater than or equal to 32.5 μm and less than or equal to 50.5 μm.

10. The MC-SMF of claim 1, wherein the low-index trench has a volume profile V_{T} and |V_{T}| is greater than or equal to 50% Δμm² and less than or equal to 900% Δμm².

11. The MC-SMF of claim 1, wherein the cladding portion further comprises an outer cladding surrounding and directly contacting the low-index trench, the outer cladding comprising an outer radius r₄ and a relative refractive index Δ₄ relative to undoped silica glass.

12. The MC-SMF of claim 11, wherein the low-index trench has a radial width equal to r₃−r₂ and r₃−r₂ is greater than or equal to 2.0 μm and less than or equal to 10.0 μm.

13. The MC-SMF of claim 11, wherein the low-index trench has a volume profile V_{T} and |V_{T}| is greater than or equal to 50% Δμm² and less than or equal to 150% Δμm².

14. The MC-SMF of claim 1, wherein the MC-SMF comprises a fiber core cutoff wavelength of less than or equal to 1300 nm.

15. The MC-SMF of claim 1, wherein the mode field diameter MFD is greater than or equal to 13.0 μm and less than or equal to 15.0 μm at a wavelength of 1310 nm.

16. The MC-SMF of claim 1, wherein the MC-SMF comprises a 30 mm diameter bend loss of less than or equal to 0.10 dB/turn at 1310 nm.

17. A modal-conditioning, single-mode fiber (MC-SMF) comprising:
a core portion comprising a core and an inner cladding surrounding and directly contacting the core, wherein:
the core comprises an outer radius r₁ and a maximum relative refractive index Δ₁ₘₐₓ relative to undoped silica glass; and
the inner cladding comprises an outer radius r₂ and a relative refractive index Δ₂ relative to undoped silica glass; and
a cladding portion surrounding the core portion, the cladding portion comprising a low-index trench surrounding and directly contacting the inner cladding, the low-index trench comprising an outer radius r₃ and a minimum relative refractive index Δ₃ₘᵢₙ relative to undoped silica glass, wherein:
$${Δ}_{1 max} > {Δ}_{2} > {Δ}_{3 min} ;$$
Δ₂ is greater than or equal to −0.10% and less than 0.10%;
the MC-SMF comprises a mode field diameter MFD greater than or equal to 12.0 μm and less than or equal to 16.0 μm at a wavelength of 1310 nm; and
the MC-SMF comprises a 20 mm diameter bend loss of less than or equal to 0.50 dB/turn at 1310 nm.

18. An optical transceiver comprising:
a housing;
at least one receiver positioned in the housing and optically coupled to an input receptacle with an optical fiber;
at least one transmitter positioned in the housing and optically coupled to an output receptacle with a modal-conditioning, single-mode fiber (MC-SMF),
wherein:
the MC-SMF comprises a mode field diameter MFD greater than or equal to 12.0 μm and less than or equal to 16.0 μm at a wavelength of 1310 nm; and
the MC-SMF comprises a 30 mm diameter bend loss of less than or equal to 0.50 dB/turn at 1310 nm.

19. The optical transceiver of claim 18, wherein the MC-SMF comprises:
a core portion comprising a core and an inner cladding surrounding and directly contacting the core,
wherein:
the core comprises an outer radius r₁ and a maximum relative refractive index Δ₁ₘₐₓ relative to undoped silica glass; and
the inner cladding comprises an outer radius r₂ and a relative refractive index Δ₂ relative to undoped silica glass; and
a cladding portion surrounding the core portion, the cladding portion comprising a low-index trench surrounding and directly contacting the inner cladding, the low-index trench comprising an outer radius r₃ and a minimum relative refractive index Δ3 min relative to undoped silica glass, wherein:
r₂ is greater than 12.0 μm; and
$${Δ}_{1 max} > {Δ}_{2} > {Δ}_{3 min} .$$

20. The optical transceiver of claim 18, wherein the MC-SMF comprises:
a core portion comprising a core and an inner cladding surrounding and directly contacting the core,
wherein:
the core comprises an outer radius r₁ and a maximum relative refractive index Δ₁ₘₐₓ relative to undoped silica glass; and
the inner cladding comprises an outer radius r₂ and a relative refractive index Δ₂ relative to undoped silica glass; and
a cladding portion surrounding the core portion, the cladding portion comprising a low-index trench surrounding and directly contacting the inner cladding, the low-index trench comprising an outer radius r₃ and a minimum relative refractive index Δ3 min relative to undoped silica glass,
wherein:
$${Δ}_{1 max} > {Δ}_{2} > {Δ}_{3 min} ;$$
and
Δ₂ is greater than or equal to −0.10% and less than 0.10%.
